(19) United States
(12) Patent Application Publication
(10) Pub. No.: US 2022/0140297 A1
(43) Pub. Date: May 5, 2022

(54) WEARABLE BATTERY POWER BOX AND CONTROL FOR POOL VACUUM

(71) Applicants: Daniel G. Dietrich, Delray Beach, FL (US); Daniel W. Dietrich, Delray Beach, FL (US)

(72) Inventors: Daniel G. Dietrich, Delray Beach, FL (US); Daniel W. Dietrich, Delray Beach, FL (US)

(21) Appl. No.: 17/089,297

(22) Filed: Nov. 4, 2020

(51) Int. Cl. H01M 2/10

(52) U.S. Cl. CPC H01M 2/1005; H01M 2/1022

(57) ABSTRACT

A box includes a main compartment surrounded by side walls and a base, and a top cover that is movable to allow access to the interior compartment. A 12 volt battery is removably received within the compartment and is electrically connected to a power connection fitting on the exterior of the box for allowing attachment and removal of an electrical power cord that extends to a self-contained submersible swimming pool vacuum head for powering an electric motor in the vacuum head. A smart power switch on the box is operable to supply electric power to the motor in the vacuum head, and to further operate the motor at different speeds, while also detecting and clearing motor jams in the event of an obstruction in the vacuum head. A belt fitted to the box extends about the wearer's waist to secure the box on the wearer.

### BACKGROUND OF THE INVENTION

### Field of the Invention

The present invention relates to a battery power pack for powering a swimming pool vacuum and, more particularly, to a wearable battery power box that holds a removable 12 volt battery and allows for electrical connection to a fully submersible self-contained swimming pool vacuum head for supplying electrical power to the vacuum head while cleaning a swimming pool.

### Description of the Related Art

Self-contained submersible swimming pool vacuum heads having an electric motor for rotating a propeller to pick up debris on the bottom surfaces of a swimming pool are well-known, an example of which is fully disclosed in U.S. Pat. No. 5,768,734, the contents of which are fully incorporated herein by reference. Self-contained, submersible swimming pool vacuum heads of this type are typically powered by a marine-grade 12 volt battery that is considerably heavy (approximately 60 pounds) and is, therefor, usually carried on a wheeled cart from a service truck to the pool deck surrounding a swimming pool. The operator of the submersible self-contained vacuum head, typically a pool service technician, connects a submersible electrical power cord from the battery on the cart to the submersible vacuum head to supply electric power to the motor in the vacuum head. As the pool service technician moves around the sides of the pool to vacuum all the surfaces, it may be necessary to move the cart carrying the battery in the event that it is necessary to provide more slack in the power cord to reach certain areas on the bottom of the swimming pool. While this arrangement is highly efficient and is used by many pool service companies throughout the country, there are times when it would be more convenient to have a lightweight self-contained submersible swimming pool vacuum head that is powered by a smaller and much lighter battery, particularly when there is a need to only clean one or two swimming pools in a day. For example, a supervisor of a swimming pool service company may need to respond to a customer in order to do an emergency pool cleaning service. Moreover, a homeowner may desire to have a self-contained battery powered submersible pool vacuum head similar to the type disclosed in U.S. Pat. No. 5,768,734, but on a smaller scale that is lighter in weight and easier to handle. For these circumstances, a lighter weight submersible swimming pool vacuum head may be made to be powered by a smaller battery that is easier for a homeowner or service technician to handle. And, due to the smaller size battery that is also lighter in weight, it would not be necessary to have a wheeled cart for carrying the battery.

Accordingly, to address the need for an easier to handle self-contained fully submersible swimming pool vacuum head, there is a need for a battery power box that can be worn on the user while cleaning the swimming pool, and wherein the battery box contains a lightweight, removable battery that can be easily interchanged with a fully charged battery as the need arises, and further wherein the battery box includes a convenient electrical connection fitting for connecting a power cord to the vacuum head. Moreover, there is a need for a battery power box for containing a smaller, lighter weight battery for powering a self-contained submersible swimming pool vacuum head, and wherein the battery power box includes a smart switch that is easily operable between an ON state and an OFF state, to provide electrical power to the submersible swimming pool vacuum head, and to turn off the power supply when needed. Moreover, there is a need for a smart power switch on a wearable battery power box for operating the electric motor of a submersible swimming pool vacuum head at different speeds, and further wherein the smart switch is able to detect motor jams (i.e., caused by an object jammed in the rotating propeller of the vacuum head) and to operate the motor in a reverse direction in an attempt to clear the obstruction in the vacuum head.

### SUMMARY OF THE INVENTION

The present invention is directed to a wearable battery power box and control for a self-contained submersible swimming pool vacuum assembly. The battery power box includes a main compartment surrounded by side walls and a base, and a top cover that is movable to allow access to the interior compartment. A 12 volt lithium battery is removably received within the compartment and is electrically connected to a power connection fitting on the exterior of the box for allowing attachment and removal of an electrical power cord that extends to a self-contained submersible swimming pool vacuum head for powering an electric motor in the vacuum head. A smart power switch on the battery power box is operable to supply electric power to the motor in the vacuum head, and to further operate the motor at different speeds, while also detecting and clearing motor jams in the event of an obstruction in the vacuum head. A belt fitted to the battery power box extends about the wearer's waist to secure the battery power box on the wearer. An exterior of the battery power box includes a concave shaped portion for conforming, fitted engagement on a wearer's hip with the belt secured about the wearer's waist.

These and other objects, features and advantages of the present invention will become clearer when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a perspective view illustrating a user wearing the battery power box of the present invention, wherein the battery power box is worn on the user's hip and is electrically connected to a self-contained submersible swimming pool vacuum being used to clean the bottom surfaces of a swimming pool;

FIG. 2 is a perspective view of the wearable battery power box and control of the present invention shown with a waterproof power supply cord disconnected from a power connection fitting on the exterior of the battery power box; and

FIG. 3 is an exploded perspective view showing a top cover of the wearable battery power box open with a battery removed from the storage compartment of the box, and further showing the power connection fitting and a smart switch separated from the side of the battery box.

Like reference numerals refer to like parts throughout the several views of the drawings.

### DETAILED DESCRIPTION OF THE PREFERRED EMBODIMENT

Referring to the several views in the drawings, the present invention is shown and is directed to a wearable battery power box 10 and control for operating a self-contained submersible swimming pool vacuum head.

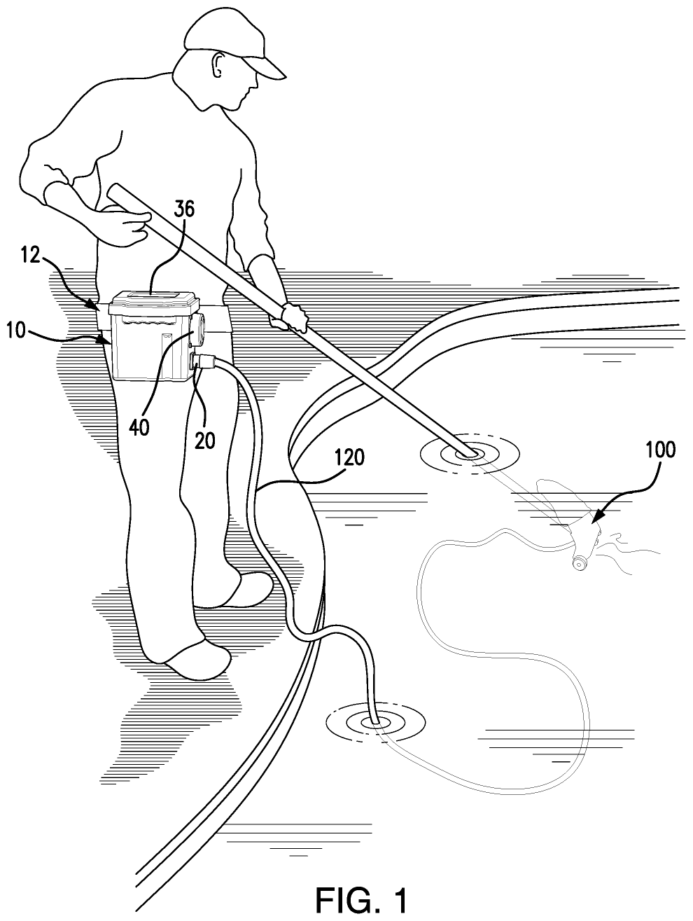

As seen in FIG. 1, the wearable battery power box 10 is intended to be worn on a user's hip, with a belt 12 fitted to the battery power box 10 and secured about the user's waist, thereby holding the battery power box 10 on the wearer's hip as the user vacuums the surfaces of a swimming pool. The wearable battery power box 10 is specifically structured for removable connection of a waterproof power cord 120 that extends from the battery power box, while worn on the user, and to the self-contained submersible swimming pool vacuum head 100.

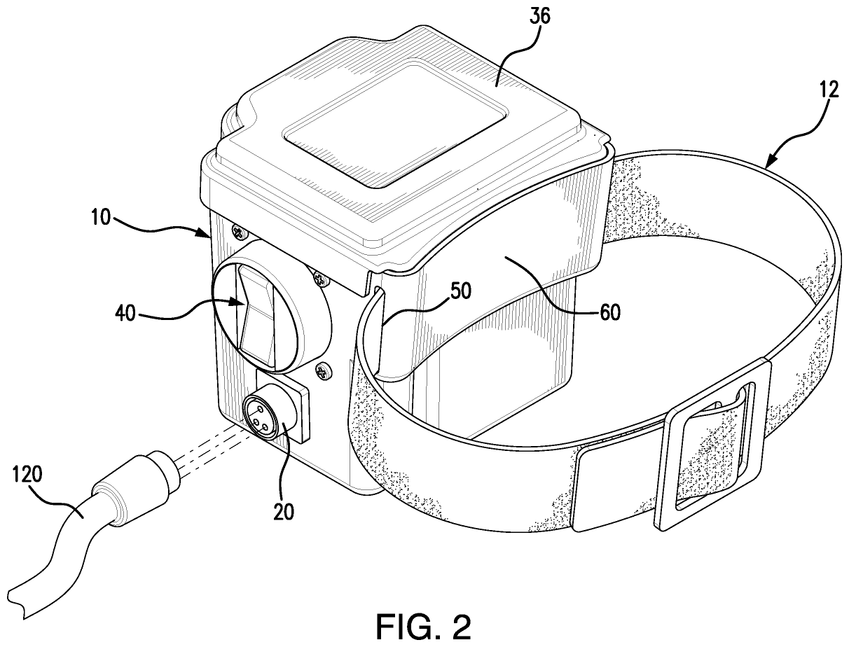

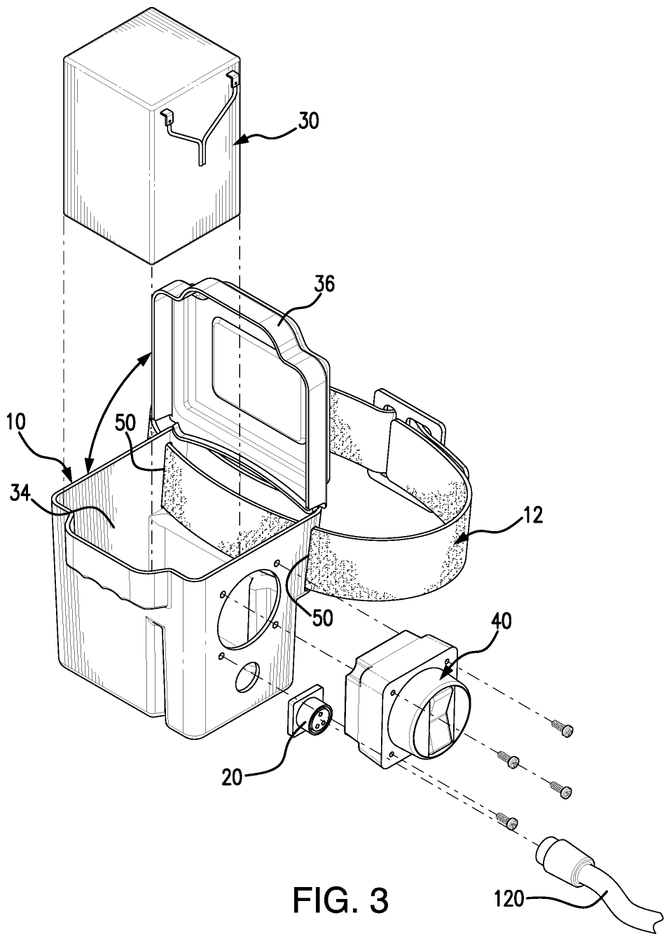

As seen in FIG. 2, a power connection fitting 20 on an exterior of the battery power box 10 allows for removable connection of the waterproof power cord 120 thereto in order to provide electrical power from a 12 volt lithium battery 30 contained within the battery power box 10 to operate an electric motor and rotating propeller in the submersible swimming pool vacuum head 100. In a preferred embodiment, the 12 volt lithium battery 30 weighs between 3-4 pounds. As seen in FIGS. 2 and 3, the battery power box 10 includes a smart switch 40 that is operable between an ON position and an OFF position for providing electric power from the battery 30 contained within an interior compartment 34 of the battery power box 10 to the electric motor of the submersible swimming pool vacuum head 100. The smart switch 40 is further structured to allow for operation of the electric motor at different speeds. The smart power switch is electrically connected to the battery 30 and the power connection fitting 20 and controls the amount of electric power delivered from the battery 30 to the power connection fitting. Moreover, the smart switch 40 is structured for detecting and clearing motor jams in the submersible swimming pool vacuum head. Upon detecting a jam or obstruction in the swimming pool vacuum head, the smart switch 40 operates the motor in the pool vacuum head in a reverse direction in an attempt to clear the obstruction. If the obstruction is not cleared, the smart switch 40 will shut off the motor by interrupting power from the battery 30 to prevent damage to the motor. An example of the smart switch 40 is fully disclosed in U.S. Pat. No. 10,224,839, the contents of which are fully incorporated herein by reference.

The interior compartment 34 of the battery power box 10 has an open top. A top cover 36 is hinged to the battery power box and is operable between a closed position to cover the open top of the compartment, as seen in FIG. 2, and an open position to allow for removal of the battery 30, as seen in FIG. 3. The belt 12 extends through slots 50 on opposite sides of the battery power box, as seen in FIGS. 2 and 3, to allow the battery power box 10 to be secured to the user. More specifically, the belt 12 extends around the wearer's waist and the battery power box is held on the user's hip, as seen in FIG. 1. An exterior portion 60 on the back of the battery power box 10 has a concave shape to generally conform with the shape of the wearer's hip so that the battery power box 10 can be securely and comfortably held on the wearer's hip when the belt is secured around the wearer's waist.

Since many modifications, variations and changes in detail can be made to the described embodiments of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A battery power apparatus comprising:
a power box having a main compartment surrounded by side walls and a base, and a top cover that is movable relative to an open top of the main compartment to allow access to the main compartment;
a power connection fitting on the power box and accessible on an exterior thereof, and the power connection fitting being structured for attachment of an electrical power cord thereto;
a battery power source removably received within the main compartment and electrically connected to the power connection fitting for providing electric power thereto;
a smart power switch on the power box and electrically connected to the battery power source and the power connection fitting, and the smart power switch being structured and disposed for controlling an amount of electric power delivered from the battery power source to the power connection fitting, and the smart power switch being further structured and disposed to interrupt power from the battery power source to the power connection fitting;
the power box having an exterior concave shaped portion for conforming, fitted engagement on a user's hip; and
a belt fitted to the power box and being structured and disposed to be secured about the user's waist to hold the battery power box on the user's body.

2. The battery power apparatus as recited in claim 1 wherein the battery power source is a 12 volt lithium battery.

3. The battery power apparatus as recited in claim 2 wherein the 12 volt lithium battery weighs between 3-4 pounds.

4. The battery power apparatus as recited in claim 1 wherein the battery power apparatus is structured for use in conjunction with a submersible self-contained vacuum head for supplying electric power and control commands to the submersible self-contained vacuum head.

5. The battery power apparatus as recited in claim 4 further comprising an electric power cord for connection to the power connection fitting on the power box and the submersible self-contained vacuum head to supply electric power from the battery power source to the submersible self-contained vacuum head.
